(19) United States
(12) Patent Application Publication
(10) Pub. No.: US 2026/0019734 A1
(43) Pub. Date: Jan. 15, 2026

(54) HEADPHONE WITH AUTOMATIC POSITION ADJUSTMENT

(71) Applicant: Shenzhen XinShuoYa Electronics Co.,Ltd, Shenzhen (CN)

(72) Inventors: Haijun LU, Chengdu (CN); Zheng WANG, Shenzhen (CN)

(73) Assignee: Shenzhen XinShuoYa Electronics Co.,Ltd, Shenzhen (CN)

(21) Appl. No.: 19/006,177

(22) Filed: Dec. 30, 2024

(30) Foreign Application Priority Data
Jul. 12, 2024 (CN) 202421645733.6
Oct. 14, 2024 (CN) 202422472964.8

(51) Int. Cl. H04R 1/10

(52) U.S. Cl. CPC H04R 1/1041; H04R 1/1008; H04R 1/105; H04R 1/1075

(57) ABSTRACT

A headphone with automatic position adjustment, comprising a speaker fastener, a speaker unit and an ear hook. There is a first accommodation space with at least one opening on the speaker fastener, at least two through holes on side walls of the speaker fastener, and at least two studs on side walls of the speaker unit in the first accommodation space; when the speaker unit is assembled into the first accommodation space, the studs are respectively clamped in the corresponding holes, and can move freely. In the present disclosure, the speaker unit is fixed in the first accommodation space of the speaker fastener by the stud and the hole. When in use, the user's ears or skin will exert a pressure on the speaker unit. Since the stud can move freely in the hole, the speaker unit will adjust its position automatically according to the pressure.

### CROSS-REFERENCE TO RELATED APPLICATIONS

The application claims priority to Chinese patent application No. 202422472964.8, filed on Oct. 14, 2024 and Chinese patent application No. 202421645733.6, filed on Jul. 12, 2024, the entire contents of which are incorporated herein by reference.

### TECHNICAL FIELD

The present disclosure relates to a headphone, in particular to a headphone with automatic position adjustment.

### BACKGROUND

With the development of headphone technology, the size of a headphone is getting smaller and smaller. The supra-aural earphones are currently more and more popular. For an air conduction headphone, the speaker units is in contact with the user's ear when in use; for a bone conduction headphone, the speaker unit is in contact with the user's skin. However, the size of the user's head is not the same, the ears and the face are different, so it is difficult to ensure that the speaker unit fits the user's ear or skin perfectly for a supra-aural earphone, even if it does, the uneven force is applied to the ear or skin contact area, resulting in high pressure in some areas and low pressure in other areas. Finally, the user feels uncomfortable after a long time, which reduces the user experience.

### SUMMARY

The present disclosure proposes a headphone with automatic position adjustment to solve the problems that after the headphone is worn, the speaker unit cannot fit perfectly with the user's ear or skin, and the area where the speaker unit comes into contact with the user's ear or skin is stressed unevenly.

A headphone with automatic position adjustment, comprising:
A speaker fastener, wherein there is a first accommodation space with at least one opening on the speaker fastener, and at least two through holes on side walls of the speaker fastener, and the holes are connected with the first accommodation space;
A speaker unit, wherein at least two studs are fixed on the side wall of the speaker unit, the number of the studs is the same as that of the holes and their positions correspond to each other, and the speaker unit is arranged in the first accommodation space;
An ear hook, fixedly connected with the speaker fastener;
Wherein, when the speaker unit is assembled into the first accommodation space, the studs are respectively clamped in the corresponding holes, and the studs can move freely for adjusting the position of the speaker unit in the first accommodation space.

Further, the stud is a cylinder, and the hole is a waist-shaped hole or a round hole.

Further, there are 3˜5 studs which are uniformly arranged on the speaker unit, and there are 3˜5 holes which are uniformly arranged on the speaker fastener.

Further, one end of the speaker unit facing the user protrudes from an opening of the first accommodation space.

Further, the shortest distance between the end face of the speaker unit facing the user and the speaker fastener is 0.1 mm˜10 mm.

Further, the shortest distance between the end face of the speaker unit facing the user and the speaker fastener is 0.5 mm˜5 mm.

Further, the first accommodation space is a hole through the speaker fastener.

Further, the speaker fastener comprises an upper fastener and a lower fastener; one part of the hole is arranged on the upper fastener, and the other part of the hole is arranged on the lower fastener.

Further, the hole wall is at least partly made of flexible material, and/or the contact part between the stud and the hole is at least made of flexible material.

The ear hook comprises a connector, a rotating mechanism and an ear hook body; one end of the connector is fixedly connected with the speaker fastener, the other end of the connector is rotatably connected with one end of the ear hook body, and the ear hook body is used for fixing the headphone on the user's head;

The headphone with automatic position adjustment further comprises a play mode adjustment mechanism for adjusting a play mode of the headphone;

The switching of the play mode of the headphone is realized by adjusting the position or the rotation angle of the rotating mechanism.

Further, a second accommodation space is arranged at one end of the connector near the ear hook body, and the rotating mechanism comprises a gear, a stop member and a reset mechanism; the stop member and the reset mechanism are arranged in the second accommodation space, a rotary shaft passes through the stop member and the connector in turn, the gear is fixedly arranged at one end of the ear hook body near the connector, the circumference of the gear is only partially toothed, the stop member matches with the gear, and the stop member is used to control the rotation angle of the rotating mechanism.

Further, the reset mechanism comprises an elastic element, one end of the elastic element abuts against the connector, and the other end of the elastic element abuts against the bottom of the second accommodation space; when the rotating mechanism rotates, the elastic element controls the rotation angle of the rotating mechanism by pushing the stop member to engage with or disengage from the tooth socket of the gear.

Further, the outer surface of the ear hook is provided with a protective layer which is made of elastic material.

Further, the elastic material covering the outer surface of the ear hook has a fold shape at the position of the rotary shaft.

Further, the play mode adjustment mechanism comprises a magnet and a sensor, the magnet is arranged on the connector or the ear hook body, and the sensor is arranged on another connector or ear hook body.

Further, there are at least two magnets which are spaced apart from each other.

Further, the connector is provided with a telescopic mechanism for controlling the length of the connector.

The beneficial effects of the present disclosure are as follows:

In the present disclosure, at least two studs are arranged on the side wall of the speaker unit, at least two through holes are arranged on the side wall of the speaker fastener, and the number of the studs is the same as that of the holes and their positions correspond to each other; the speaker unit is fixed in the first accommodation space of the speaker fastener by the stud and the hole; when in use, the user's ears or skin will exert a pressure on the speaker unit; since the stud can move freely in the hole, the speaker unit is brought into maximum contact with the user's ear or skin, so that the pressure tends to be uniform in the area where the speaker unit is in contact with the user's ear or skin, thus improving user experience.

### BRIEF DESCRIPTION OF DRAWINGS

The exemplary embodiments in the present disclosure and descriptions thereof are not intended to limit the present invention, but only to explain the present invention. In the drawings:

FIG. 1 is a 3D structure diagram of a headphone with automatic position adjustment according to the present disclosure;

FIG. 2 is a 3D structure diagram of a speaker fastener and speaker unit assembled according to an embodiment in the present disclosure;

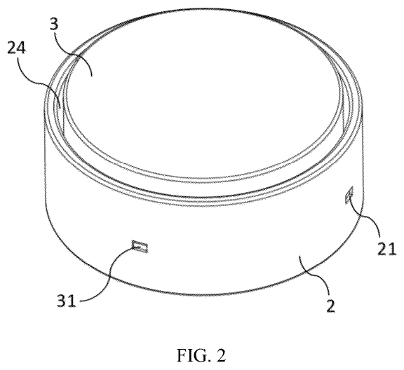

FIG. 3 is a 3D structure diagram of a speaker unit according to an embodiment in the present disclosure;

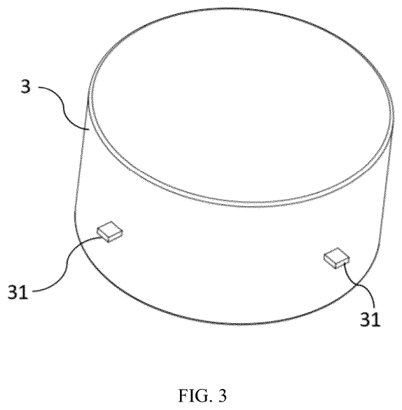

FIG. 4 is a 3D structure diagram of a speaker fastener and speaker unit assembled according to another embodiment in the present disclosure;

FIG. 5 is a 3D structure diagram of a speaker fastener and speaker unit assembled according to still another embodiment in the present disclosure;

FIG. 6 is an exploded view of right side of a headphone with automatic position adjustment according to the present disclosure;

FIG. 7 is a 3D structure diagram of the first structure of the rotating mechanism according to the present disclosure;

FIG. 8 is a structure diagram of the second structure of the rotating mechanism according to the present disclosure;

FIG. 9 is a structure diagram of the third structure of the rotating mechanism according to the present disclosure;

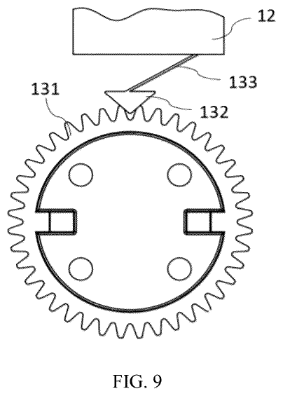

FIG. 10 is a structure diagram of the fourth structure of the rotating mechanism according to the present disclosure.

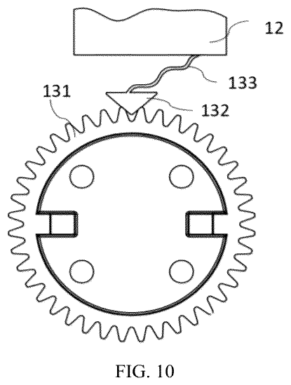

In the drawings: 1—ear hook; 11—ear hook body; 12—connector; 13—rotating mechanism; 131—gear; 132—stop member; 133—reset mechanism; 2—speaker fastener; 21—hole; 22—upper fastener; 23—lower fastener; 24—first accommodation space; 3—speaker unit; 31—stud.

### DETAILED DESCRIPTION OF THE EMBODIMENTS

In the present disclosure, unless otherwise stated, words such as “upper, lower, top and bottom” are usually used for directions shown in the drawings or for parts themselves in vertical, vertical or gravitational directions; similarly, to facilitate understanding and description, “inside and outside” refer to inside and outside relative to the outline of each part itself, but the above direction words are not used to limit the present disclosure.

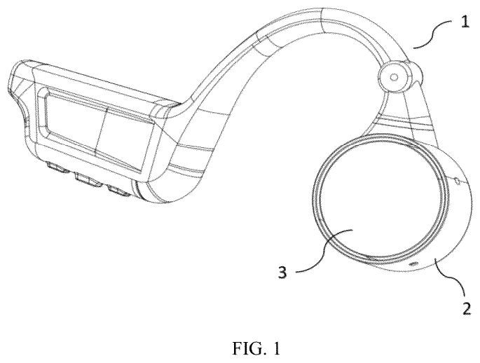

As shown in FIGS. 1˜3, a headphone with automatic position adjustment is proposed according to one aspect of the present disclosure, comprising:

A speaker fastener 2, wherein there is a first accommodation space 24 with at least one opening on the speaker fastener 2, and at least two through holes 21 on side walls of the speaker fastener 2, and the holes 21 are connected with the first accommodation space 24;

A speaker unit 3, wherein at least two studs 31 are fixed on the side wall of the speaker unit 3, the number of the studs 31 is the same as that of the holes 21 and their positions correspond to each other, and the speaker unit 3 is arranged in the first accommodation space 24; the stud 31 can be integrated with the speaker unit 3, for example, by integral injection molding or by welding later. Of course, the stud 31 can also be separated from the speaker unit 3, for example, the stud 31 is detachably or fixedly connected with the speaker unit 3 by clamps.

An ear hook 1, fixedly connected with speaker fastener 2, preferably in a detachable manner.

Wherein the cross-sectional area of the stud 31 is equal to or smaller than that of the hole 21, when both the cross-sectional areas of the stud 31 and the hole 21 are circular and the cross-sectional area of the stud 31 is equal to that of the hole 21, the stud 31 can rotate in the hole 21; when the cross-sectional area of the stud 31 is smaller than that of the hole 21, the stud 31 can move freely in the hole 21; when the speaker unit 3 is assembled into the first accommodation space 24, the studs 31 are respectively clamped in the corresponding holes 21. Since the stud 31 can rotate or move freely in the hole 21 and the stud 31 is fixed on the speaker unit 3, the speaker unit 3 can rotate or move freely in the first accommodation space 24 to adjust the position of the speaker unit 3 in the first accommodation space 24.

In this embodiment, at least two studs 31 are arranged on the side wall of the speaker unit 3, at least two through holes 21 are arranged on the side wall of the speaker fastener 2, and the number of the studs 31 is the same as that of the holes 21 and their positions correspond to each other; the speaker unit 3 is fixed in the first accommodation space 24 of the speaker fastener 2 by the stud 31 and the hole 21.

When in use, the user's ears or skin will exert a pressure on the speaker unit 3; since the stud 31 can rotate or move freely in the hole 21, the speaker unit 3 is brought into maximum contact with the user's ear or skin, so that the pressure tends to be uniform in the area where the speaker unit 3 is in contact with the user's ear or skin, thus improving user experience.

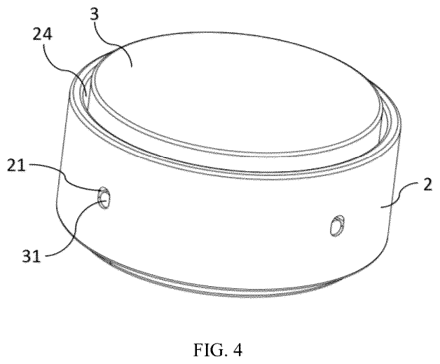

In one embodiment, as shown in FIG. 4, there are two studs 31 and two holes 21, and stud 31 is a cylinder or an elliptic cylinder. A cylinder is preferred; the hole 21 is a waist-shaped hole or a round hole, and the stud 31 is smaller than the waist-shaped hole or the round hole. A small stud 31 can easily move freely in the hole 21, and it is easier to machine the stud 31 and the hole 21.

When there are two studs 31 and two holes 21, and the two studs 31 and the two holes 21 are arranged symmetrically, when the speaker unit 3 is in contact with the user's ear or skin, the stud 31 of the first contact area of the speaker unit 3 can move in the hole 21, and the speaker unit 3 tilts up and down along the connecting line between the two studs 31. At the same time, the stud 31 can rotate around the axis of the stud 31 in the hole 21. Therefore, the speaker unit 3 can rotate around the axis of the stud 31 in the first accommodation space 24, so that the speaker unit 3 has at least two degrees of freedom. If it is considered that the speaker unit 3 moves left and right along the connecting line the two studs 31, the speaker unit 3 has three degrees of freedom, so that the position of the speaker unit 3 can be adjusted according to the size of the user's head and the shape of the contact surface, the speaker unit 3 is in maximum contact with the user's head and the pressure tends to be uniform, which improves the comfort of the user and the user experience.

If the two studs 31 and the two holes 21 are not arranged symmetrically, and the cross-sectional area of the stud 31 is smaller than that of the hole 21, the stud 31 can move freely in the hole 21, the stud 31 can move up and down in the hole 21 by a degree of freedom, the speaker unit 3 can tilt along the line connecting the centers of the two holes 21 by a second degree of freedom, and the adjustment effect for the symmetrical arrangement of the stud 31 and the hole 21 is better than that of the asymmetrical arrangement, with a larger adjustment range.

In one embodiment, as shown in FIG. 4, there are 3˜5 studs 31 which are evenly arranged on the speaker unit 3. There are 3˜5 holes 21 which are uniformly arranged on the speaker fastener 2.

In order to prevent the rotation angle of the speaker unit 3 from being too large, and to prevent the strength of the two studs 31 from being small, the studs 31 may be broken when the speaker unit 3 is subjected to a relatively large external force, and this problem can be solved by increasing the number of studs 31. The number of the studs 31 and the holes 21 is preferably 3˜5.

For example, when there are 3 studs 31 and 3 holes 21 and they are arranged uniformly, and the speaker unit 3 comes into contact with the ear or skin of the user, the stud 31 in the first contact area moves downward in the corresponding hole 21, the other two studs 31 move correspondingly in respective holes 21 according to the order in which they come into contact with the user's ear or skin, wherein the stud 31 in the last contact area moves upward in its hole 21, just like three adjustment points control the position of the speaker unit 3 in the first accommodation space 24, so that the speaker unit 3 can be adjusted according to the shape of the user's ear or skin position, to make the whole speaker unit 3 in contact with the user's head to the maximum extent and keep the uniform pressure.

For 4 or 5 studs 31 and holes 21, and the working principle is the same as that of 3 studs 31 and holes 21, which will not be described again.

In one embodiment, as shown in FIG. 4, one end of the speaker unit 3 facing the user protrudes from an opening of the first accommodation space 24. The shortest distance between the end face of the speaker unit 3 facing the user and the speaker fastener 2 is 0.1 mm˜10 mm.

One end of the speaker unit 3 facing the user protrudes from the first accommodation space 24, and part of the loudspeaker unit 3 is outside the first accommodation space 24. When the headphone is worn, the loudspeaker unit 3 comes into contact with the user's ear or skin at first, reducing the impact of the speaker fastener 2 on the contact between the speaker unit 3 and the user.

Preferably, the shortest distance between the end face of the speaker unit 3 facing the user and the speaker fastener 2 is 0.5 mm˜5 mm. When the distance is less than 0.5 mm, the user's ears or skin may come into contact with the speaker fastener 2, preventing the position adjustment of the speaker unit 3, and when the distance is more than 5 mm, the speaker is too thick, affecting the appearance and storage of the headphone.

Preferably, the first accommodation space 24 is a hole through the speaker fastener 2.

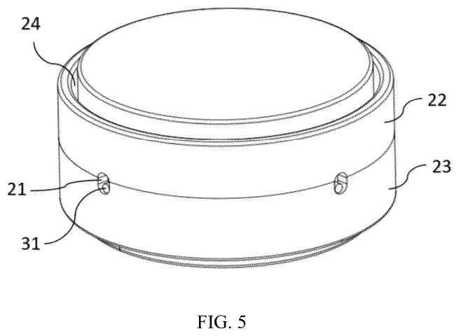

In one embodiment, as shown in FIG. 5, the speaker fastener 2 comprises an upper fastener 22 and a lower fastener 23; one part of the hole 21 is arranged on the upper fastener 22, and the other part of the hole 21 is arranged on the lower fastener 23. The split-type design is adopted to facilitate the assembly of the speaker unit 3 on the speaker fastener 2.

In one embodiment, the wall of hole 21 is at least partly made of flexible material. The contact part between the stud 31 and the hole 21 is at least made of flexible material. The use of flexible materials can prevent the abnormal sound caused by sliding friction between the stud 31 and the hole 21 during the position adjustment of the speaker unit 3.

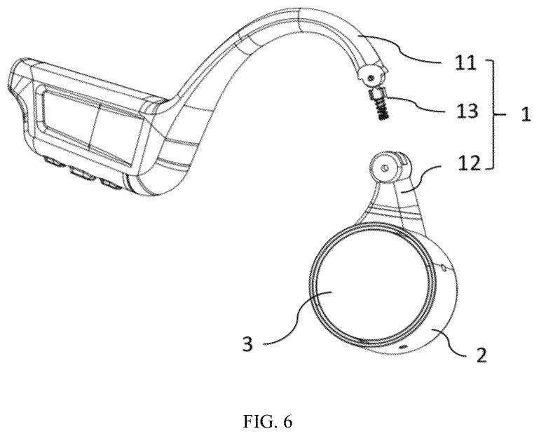

As shown in FIG. 6, the ear hook comprises an ear hook body 11, a connector 12 and a rotating mechanism 13; one end of the connector 12 is fixedly connected with the speaker fastener, the other end of the connector 12 is rotatably connected with one end of the ear hook body 11, and the ear hook body 11 is used for fixing the headphone on the user's head.

The headphone with automatic position adjustment further comprises a play mode adjustment mechanism for adjusting a play mode of the headphone.

The switching of the play mode of the headphone is realized by adjusting the position or the rotation angle of the rotating mechanism 13.

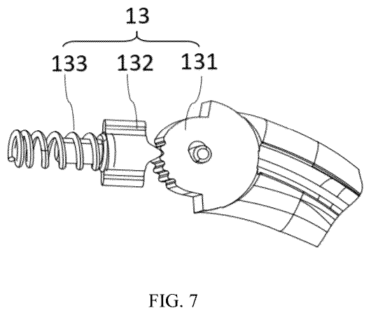

As shown in FIG. 7, the rotating mechanism 13 comprises a gear 131, a stop member 132 and a reset mechanism 133. The gear 131 is fixed at one end of the ear hook body 11 close to the connector 12. A second accommodation space (not shown in the figure) is arranged at one end of the connector 12 near the ear hook body 11. The stop member 132 and the reset mechanism 133 are arranged in the second accommodation space, and a rotary shaft passes through the stop member 132 and the connector 12 in turn, the stop member 132 is matched with the gear 131, and the stop member 132 is used to control a rotation angle of the rotating mechanism 13. The gear 131 is distributed with teeth over the entire circumference, which allows for large angle rotation, or it is partially toothed, the latter is preferred.

The reset mechanism 133 comprises an elastic element and a positioning stud, the positioning stud is arranged at one end of the connector 12 away from the ear hook body 11, one end of the elastic element abuts against the connector 12 through the positioning stud, and the other end of the elastic element abuts against the bottom of the second accommodation space. Preferably, the elastic element is a spring, rubber, silica gel or other elastic part. When the rotating mechanism 13 rotates, the elastic element controls the rotation angle of the rotating mechanism 13 by pushing the stop member 132 to engage with or disengage from the tooth socket of the gear 131 by elastic force.

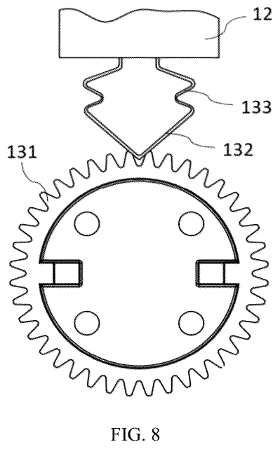

As shown in FIG. 8˜10, the elastic elements may also be elastic arms (one or more elastic arms); preferably there are two bendable elastic arms, and more preferably the two bendable elastic arms bend in opposite directions.

The elastic element may be fixedly connected to the connector 12 in a detachable or non-detachable manner, preferably a detachable manner.

A play mode adjustment mechanism for adjusting a play mode of the headphone;

The switching of the play mode is realized by adjusting the position or the rotation angle of the rotating mechanism 13.

In this embodiment, when the headphone with automatic position adjustment is used, the speaker fastener 1 and the connector 12 are driven to rotate by rotating the rotating mechanism 13. In the rotation process, a trigger signal will be triggered correspondingly and sent to the headphone processor according to a different position or rotation angle. The headphone processor recognizes the trigger signal and then sends a command correspondingly, and then sends play mode according to the command; the headphone processor plays content or adjusts the play mode correspondingly.

The side of the stop member 132 near the gear 131 is in an acute angle shape and it can be clamped into the gear groove. The elastic element is arranged behind the stop member 132, that is, in the direction where the stop member 132 is away from the gear 131. When the rotating mechanism 13 rotates, the elastic force of the elastic element pushes the stop member 132 to be clamped into the gear groove. The user rotates the speaker fastener 1 or the connector 12 to drive the rotating mechanism 13 to rotate; the stop member 132 is pressed by the teeth on the gear 131 and retracts backward. In the process of retraction, the elastic element is compressed, and the stop member 132 continues to move to the next gear groove after passing through the tooth crest. When the rotating member rotates to the position of the next gear groove of gear 131, the stop member 132 is pushed into the next gear groove under the pushing force of the elastic element, and the stop member 132 collides with the gear groove and makes a sound; when the rotating mechanism 13 rotates all the time, under the joint action of the gear 131 and the elastic element, the stop members 132 collide with the gear grooves in sequence along the circumference of gear 131 and make a rattling sound; when the rotating mechanism 13 stops, the stop member 132 is stuck into the gear groove and stops, and the stop member 132 and the gear groove play a stop role to prevent the rotating member from continuing to rotate.

Due to the rotation of the rotating mechanism 13, it may be used in the following scenarios. The headphone has two loudspeaker units 3 corresponding to the user's two ears respectively. In a noisy environment, if the user wants to block external noise to a certain extent and does not want to miss other useful sound, he/she may choose to adjust only one rotating mechanism 13 so that the speaker unit 3 covers the right ear. For example, the noise is mainly emitted from the left side, so it needs to only adjust the left rotating mechanism 13 to make the left speaker unit 3 cover the left ear, thus to filter the noise on the left side to some extent.

In a relatively quiet environment, the left and right rotating mechanisms 13 are adjusted to keep the speaker body away from the ears, thus avoiding ear discomfort after a long time. The user can also hear other sounds, so as to prevent other useful sounds from being missed.

In one embodiment, the outer surface of the headphone with automatic position adjustment is provided with a protective layer, the protective layer at least covers the outer surface of the ear hook, and the protective layer covering the outer surface of the ear hook is made of elastic material.

During the rotation of the rotating mechanism 13, the protective layer of the elastic material is stretched or compressed as the rotating mechanism 13 rotates; since the elastic material is stretched or compressed within certain limits and there is some resistance to rotation during rotation, and the protective layer will be damaged when the limit of the elastic material is exceeded, preferably the elastic material covering the outer surface of the ear hook has a fold shape at the position of the rotary shaft (not shown in the drawing) to reduce the resistance of the elastic element and prevent damage to the protective layer.

In one embodiment, the play mode adjustment mechanism comprises a magnet and a sensor, the magnet is arranged on the connector 12 or the ear hook body 11, and the sensor is arranged on another connector 12 or ear hook body 11. There are at least two magnets which are spaced apart from each other.

The headphone can adjust the sound volume, the play and pause of audio and the play of different styles of audio through the play mode adjustment mechanism.

The following details the principle of headphone adjustment by adjusting different styles of audio as an example.

A sensor is arranged on the connector 12, and a first magnet and a second magnet are arranged on the ear hook body 11. When the rotating mechanism 13 rotates to a position, the sensor can sense the first magnet, and the sensor sends a first signal to the headphone processor. After receiving the first signal sent by the sensor, the headphone processor sends a command for playing audio of the first style, and the headphone plays audio according to the list of the first style audio; when the user continues to rotate the rotating mechanism 13, the sensor cannot sense the first magnet, and the headphone stops playing (the user can also set the headset to continue playing the first style audio); when the user continues to rotate the rotating mechanism 13 and the sensor senses the second magnet, the sensor sends a second signal to the headphone processor, and after receiving the second signal sent by the sensor, the headphone processor sends a command for playing the audio of the second style, so the headphone plays audio according to the list of the second style audio.

Similarly to the principle of adjusting the sound volume by rotating the rotation mechanism 13, the user can also set up several magnets to control the volume, play mode, etc.

It should be noted that the specific setting position of the magnet and sensor is not limited, as long as the sensor can sense the magnet and control the playback mode during the rotation of the rotating mechanism 13, continue to rotate to get rid of the sensing, and continue to rotate to sense the next magnet, and thus to switch the playback mode.

Of course, the method for controlling the above playback mode is not limited to the magnetic field sensing. For example, the motion sensing may also be used to control the playback mode, that is, when the headphone senses that the user is in a motion state, it plays passionate music to adapt to the user's state of motion; and when the headphone detects that the user is still, it switches to a soft music playback mode, which can be realized by a built-in motion sensor or a speed sensor, and the specific working principle is similar to that of the above-mentioned magnetic field sensing mode and will not be repeated here.

The headphone can be set with several sensing modes and selection buttons. Users can select different sensing modes according to different scenarios, such as magnetic field sensing mode, motion sensing mode or infrared ray sensing mode, which are not listed here one by one.

Further, due to the different sizes of people's heads, a telescopic mechanism can be provided on the connector 12 to control the length of the connector 12 so as to adapt to different people.

Obviously, the embodiments described above are merely some of rather than all of the embodiments of the present disclosure. Based on the embodiments described herein, all other embodiments obtained by those of ordinary skill in the art without creative work are within the scope of the present disclosure.

The words used herein are only for the purpose of describing specific embodiments and are not intended to limit exemplary embodiments in accordance with the present application. Unless the context specifies otherwise, the singular form used herein is also intended to include the plural form, and it should be further understood that when the words “comprise” and/or “include” are used in this specification they indicate the existence of features, steps, activities, devices, components, and/or combinations thereof.

The words “first” and “second”, etc. in the specification, claims and drawings of the present application are used to distinguish similar objects, not necessarily to describe a specific order or precedence. It should be understood that the words so used are interchangeable where appropriate.

What is claimed is:

1. A headphone with automatic position adjustment, comprising:
A speaker fastener, wherein there is a first accommodation space with at least one opening on the speaker fastener, and at least two through holes on side walls of the speaker fastener, and the holes are connected with the first accommodation space;
A speaker unit, wherein at least two studs are fixed on the side wall of the speaker unit, the number of the studs is the same as that of the holes and their positions correspond to each other, and the speaker unit is arranged in the first accommodation space;
An ear hook, fixedly connected with the speaker fastener;
Wherein, when the speaker unit is assembled into the first accommodation space, the studs are respectively clamped in the corresponding holes, and the studs can move freely for adjusting the position of the speaker unit in the first accommodation space.

2. The headphone with automatic position adjustment according to claim 1, wherein the stud is a cylinder, and the hole is a waist-shaped hole or a round hole.

3. The headphone with automatic position adjustment according to claim 2, wherein there are 3˜5 studs which are uniformly arranged on the speaker unit, and there are 3˜5 holes which are uniformly arranged on the speaker fastener.

4. The headphone with automatic position adjustment according to claim 1, wherein one end of the speaker unit facing the user protrudes from an opening of the first accommodation space.

5. The headphone with automatic position adjustment according to claim 4, wherein the shortest distance between the end face of the speaker unit facing the user and the speaker fastener is 0.1 mm˜10 mm.

6. The headphone with automatic position adjustment according to claim 4, wherein the shortest distance between the end face of the speaker unit facing the user and the speaker fastener is 0.5 mm˜5 mm.

7. The headphone with automatic position adjustment according to claim 1, wherein the first accommodation space is a hole through the speaker fastener.

8. The headphone with automatic position adjustment according to claim 1, wherein the speaker fastener comprises an upper fastener and a lower fastener; one part of the hole is arranged on the upper fastener, and the other part of the hole is arranged on the lower fastener.

9. The headphone with automatic position adjustment according to claim 8, wherein the hole wall is at least partly made of flexible material, and/or the contact part between the stud and the hole is at least made of flexible material.

10. The headphone with automatic position adjustment according to claim 1, wherein the ear hook comprises a connector, a rotating mechanism and an ear hook body; one end of the connector is fixedly connected with the speaker fastener, the other end of the connector is rotatably connected with one end of the ear hook body, and the ear hook body is used for fixing the headphone on the user's head;
The headphone with automatic position adjustment further comprises a play mode adjustment mechanism for adjusting a play mode of the headphone;
The switching of the play mode of the headphone is realized by adjusting the position or the rotation angle of the rotating mechanism.

11. The headphone with automatic position adjustment according to claim 10, wherein a second accommodation space is arranged at one end of the connector near the ear hook body, and the rotating mechanism comprises a gear, a stop member and a reset mechanism; the stop member and the reset mechanism are arranged in the second accommodation space, a rotary shaft passes through the stop member and the connector in turn, the gear is fixedly arranged at one end of the ear hook body near the connector, the circumference of the gear is only partially toothed, the stop member matches with the gear, and the stop member is used to control the rotation angle of the rotating mechanism.

12. The headphone with automatic position adjustment according to claim 11, wherein the reset mechanism comprises an elastic element, one end of the elastic element abuts against the connector, and the other end of the elastic element abuts against the bottom of the second accommodation space; when the rotating mechanism rotates, the clastic element controls the rotation angle of the rotating mechanism by pushing the stop member to engage with or disengage from the tooth socket of the gear.

13. The headphone with automatic position adjustment according to claim 12, wherein the elastic element is a spring.

14. The headphone with automatic position adjustment according to claim 10, wherein the outer surface of the ear hook is provided with a protective layer which is made of elastic material.

15. The headphone with automatic position adjustment according to claim 14, wherein the elastic material covering the outer surface of the ear hook has a fold shape at the position of the rotary shaft.

16. The headphone with automatic position adjustment according to claim 10, wherein the play mode adjustment mechanism comprises a magnet and a sensor, the magnet is arranged on the connector or the ear hook body, and the sensor is arranged on another connector or ear hook body.

17. The headphone with automatic position adjustment according to claim 16, wherein there are at least two magnets which are spaced apart from each other.

18. The headphone with automatic position adjustment according to claim 16, wherein the connector is provided with a telescopic mechanism for controlling the length of the connector.
